(19) United States
(12) Patent Application Publication
(10) Pub. No.: US 2010/0273043 A1
(43) Pub. Date: Oct. 28, 2010

(54) ELECTROCHEMICAL CELL WITH WELD POINTS CONNECTIONS AND ENERGY STORAGE ASSEMBLY

(75) Inventors: Peter Birke, Glienicke/Nordbahn (DE); Michael Keller, Baden Baden (DE); Kazuhiro Takahashi, Yamagata (JP); Hideo Abe, Saitama (JP); Kiyoko Abe, Yamagata (JP); Kazunori Ozawa, Miyagi (JP)

Correspondence Address: RATNERPRESTIA, P.O. BOX 980, VALLEY FORGE, PA, 19482, US

(73) Assignees: Temic Automotive Electric Motors GMBH; ENAX INC

(21) Appl. No.: 12/597,377

(22) PCT Filed: Apr. 23, 2008
(86) PCT No.: PCT/EP08/03272

§ 371 Date: Jun. 14, 2010

(30) Foreign Application Priority Data
Apr. 24, 2007 (DE) 10 2007 019 625.5
May 10, 2007 (DE) 10 2007 022 436.4

(51) Int. Cl. H01M 6/46; H01M 4/02; H01M 2/30

(52) U.S. Cl. 429/158; 429/211; 180/65.21; 903/907

(57) ABSTRACT

An electrochemical cell with a pair of electrodes arranged as a stack of flat electrode films separated by a separator film, wherein: electrode films of each electrode are electrically connected with each other through inner electrode conductors, the inner electrode conductors of the different electrodes are arranged on opposite sides of the electrochemical cel in electrode material-free area of the electrode films, each inner electrode conductor is connected with the respective electrode films through a predetermined number of weld points in the electrode material-free area of the respective electrode, each inner electrode conductor includes a predetermined number of openings in which coupling elements are set to connect the inner electrode conductor with an outward electrode conductor for the respective electrode.

### CROSS REFERENCE TO RELATED APPLICATIONS

This application is the U.S. national phase application of PCT International Application No. PCT/EP2008/003272, filed Apr. 23, 2008, which claims priority to German Patent Application No. DE10 2007 019 625.5, filed on Apr. 24, 2007, and German Patent Application No. DE10 2007 022 436.4, filed on May 10, 2007, the content of such applications which is hereby incorporated by reference herein.

### FIELD OF THE INVENTION

The present invention relates to an electrochemical cell and an energy storage assembly comprising a plurality of such electrochemical cells and an electric car or a hybrid type electric car using the same. The energy storage assembly (also called battery pack) comprises a plurality of flat electrochemical cells (also called battery cells) each of them comprises a pair of electrodes which electrically connect the electrochemical cells with each other through outward terminals.

### BACKGROUND OF THE INVENTION

In order to satisfy requirements such as higher input-output power sources for applications, e.g. electric cars, hybrid cars, electric tools, etc. new energy storage assemblies, e.g. lead-acid batteries, lithium-ion batteries, nickel metal hydride batteries, nickel-cadmium batteries and electric double layer capacitors, etc. have been developed.

These new energy storage assemblies power the electric driving motor and the vehicle on-board electrical system. To control the charge-discharge procedures of the energy storage assembly a controller is integrated which manages the charge-discharge procedures, the conversion from braking energy into electric energy (=renewable braking), etc, so that the energy storage assembly can charge during vehicle operation.

The energy storage assembly or each single electrochemical cell should exhibit good characteristics such as a maximum voltage range of 100 V to 450 V with current of 400 A and for extreme condition, e.g. high temperature, with current up to 500 A. Continuous current is in the range of 80 A to 100 A or even also higher depending on the application.

For such extreme conditions the connection of the electrochemical cells of energy storage assembly is extremely stressed.

Normally, the connections are provided through crimps, screws or weld points. Often, the electrochemical cells are damaged during setting up the connection through thermal and mechanical stress.

Accordingly, an object of the present invention is to provide an electrochemical cell and an energy storage assembly whose connections shall exhibit a high reliability, e.g. up to 15 years, under extreme conditions, e.g. in a vehicle under high vibration and high temperature. Furthermore the energy storage assembly shall exhibit a good ampacity (i.e. a good current carrying capacity, whereas the connection resistance should be smaller than the internal cell resistance) and high capacity against thermal and mechanical stress.

### SUMMARY OF THE INVENTION

In order to satisfy this object, an electrochemical cell is provided with a high ampacity and a good current and thermal distribution through the novel connecting form of the electrode connection. Furthermore, the separator is definitely fixed based on the novel connecting form.

In accordance with an aspect of the invention, an electrochemical cell comprises a pair of electrodes arranged as a stack of flat electrode films separated by at least one separator film, wherein:
electrode films of each electrode are electrically connected with each other through inner electrode conductors,
the inner electrode conductors of the different electrodes are arranged on opposite sides of the electrochemical cell in electrode material-free area of the electrode films,
each inner electrode conductor is connected with the respective electrode films through a predetermined number of weld points in the electrode material-free area of the respective electrode,
each inner electrode conductor comprises a predetermined number of openings in which coupling elements are set to connect the inner electrode conductor with an outward electrode conductor for the respective electrode.

Such a combined arrangement of weld points for connecting the inner electrode films of each electrode with each other to an inner electrode conductor with coupling elements set in openings for connecting the inner electrode conductor with an outward electrode conductor for the respective electrode allows a good ampacity and current and also thermal distribution.

Preferably, the outward electrode conductor is provided as a conductor bar. In a possible embodiment, the outward electrode conductor is composed of at least copper. Additionally, the outward electrode conductor is composed of at least copper coated with a protection layer. For a good protection against corrosion the protection layer is composed of stannous or nickel or an alloy, e.g. alloy of aluminium manganese or aluminium copper. Alternatively, the outward electrode conductor can be composed of at least copper with a treated surface, e.g. with a surface treated by an electronic beam.

In accordance with a further aspect of the invention, each outward electrode conductor has a thickness of at least 1 mm. The thickness can vary based on particular applications, e.g. of the size of the electrochemical cell. The larger the cell is the larger is the thickness if the outward electrode conductor. For example, the thickness should be in the range of about 1 mm to about 3 mm. This allows that an additional active electrode surface is given by the same cell outer surface because the required conductor section is provided by the new conductor thickness. Furthermore, such a conductor thickness allows a reduction of the transition surface between inner cell and outer cell, whereby the tightness in this transition surface is increased.

For a definite fixed connection of the inner and outer electrode conductors the coupling elements are rivets, crimps or bolts or in the inner electrode conductor, especially in the inner electrode films integrated bulges or knobs, which are welded, especially through ultrasonic welding.

As a further aspect of the invention the number of weld points is greater than the number of openings or the number of coupling elements. This arrangement allows a definite fixing of the inner electrode films by a great number of fixing points and in that the separator films are also definitely fixed between the fixed electrode films. Preferably, the relation between the number of weld points and the number of openings or coupling elements is in the range between 2.0 and 3.0. For instance, if six weld points are predetermined, three openings or coupling elements will be sufficient. Furthermore, the openings or coupling elements are preferably symmetrically arranged between the weld points, e.g. alternately two weld points and one opening or coupling element.

To connect the electrochemical cell with other electrochemical cells each outward electrode conductor is connected with a respective outward terminal.

As a further aspect of the invention, an energy storage assembly is provided with definite and fail-safe connections of the electrochemical cells through so called poka-yoke (=a fail-safe contact in such a way that contact elements are designed that they do not misconnect with each other).

In accordance with another aspect of the invention, the energy storage assembly comprises a plurality of flat electrochemical cells, each of them comprises a pair of electrodes which electrically connect the electrochemical cells with each other through the outward terminals, wherein each electrochemical cell comprises as a pair of outward terminals a straight outward terminal and a curved outward terminal and wherein the electrochemical cells are connected with each other that a straight outward terminal of one of the electrochemical cell is connected with a curved outward terminal of an adjacent electrochemical cell.

Such design of the outward terminals allows that the electrochemical cells do not misconnect. Furthermore, this design allows an effective, space-saving arrangement of the electrochemical cells in a pack, e.g. in a battery or energy storage pack, in which the flat electrochemical cells are stacked on top of each other. Such a stack arrangement allows a simple and effective division of the stack into modules of a number of cells.

For a fixed, permanent, reliable connection with a high ampacity each outward terminal comprises at least one bulge.

In accordance with a further aspect of the invention, each outward terminal has a thickness of at least 1 mm. The thickness can vary based on particular applications, e.g. of the size of the energy storage assembly, especially of the size of the single electrochemical cell. The larger the assembly or cell is the larger is the thickness of the outward terminal. For example, the thickness should be in the range of about 1 mm to about 3 mm. This allows that an additional active electrode surface is given by the same cell outer surface because the required terminal section is provided by the new terminal thickness. Furthermore, such terminal thickness allows a reduction of the transition surface between inner cell and outer cell, whereby the tightness in this transition surface is increased.

In a possible embodiment of the invention, each outward terminal is composed of at least copper. In a further possible embodiment, each outward terminal is composed of at least copper coated with a protection layer. The protection layer is composed of e.g. stannous or nickel or an alloy, e.g. an alloy of aluminium manganese or aluminium copper.

Depending on the application the electrochemical cells are connected in series, parallelly or in parallel-series.

The invention can be used in electric cars, in hybrid electric vehicles, especially in parallel hybrid electric vehicles, serial hybrid electric vehicles or parallel/serial hybrid electric vehicles. Furthermore the invention can be used also for storing wind energy or other produced energy, e.g. solar energy.

The present invention is now further described with particular reference to the following embodiments in the drawing. However, it should be understood that these embodiments are only examples of the many advantageous uses of the innovative teachings herein.

### BRIEF DESCRIPTION OF THE DRAWINGS

FIG. 1 shows a view of an energy storage assembly with a plurality of electrochemical cells which are connected with each other through pairs of outward terminals of each cell,

FIG. 2 shows a view of one of the electrochemical cells.

### DETAILED DESCRIPTION OF THE DRAWINGS

The present invention relates to an electrochemical cell and an energy storage assembly comprising a plurality of these cells. The invention can be used for different applications, e.g. in a hybrid electric vehicle, whereby the hybrid electric vehicle having a driving motor and an internal combustion engine, wherein the driving motor is driven by power supplied from the energy storage assembly. Alternatively, the energy storage assembly can also be used in an electric car having a driving motor driven by power supplied from the energy storage assembly. Furthermore the energy storage assembly can be used for storing wind or solar energy for which the assembly is integrated in a wind or solar energy plant.

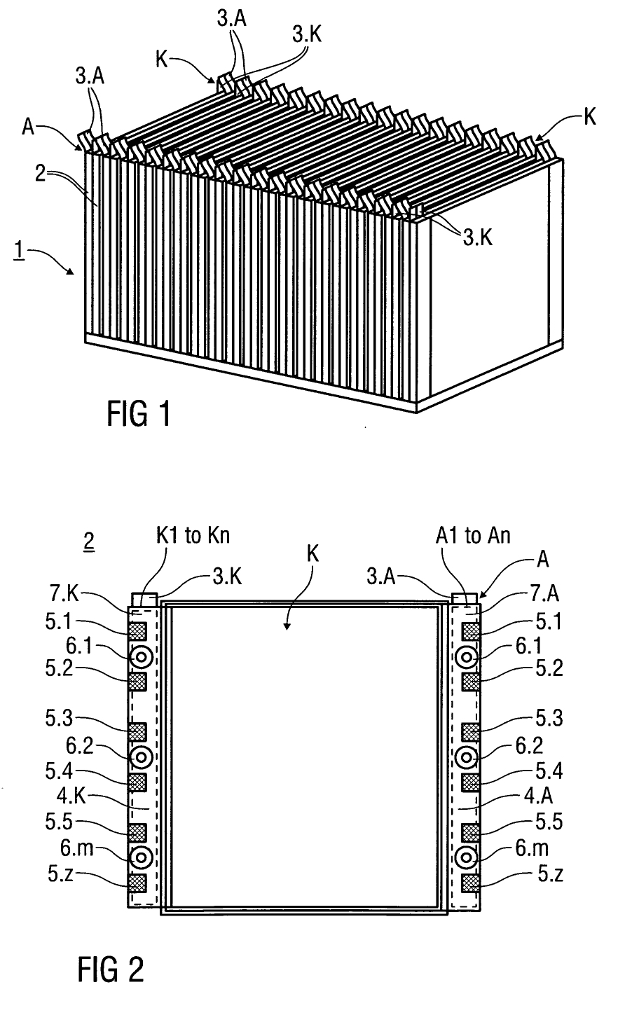

FIG. 1 shows a view of an energy storage assembly 1 (also called battery pack) with a plurality of flat electrochemical cells 2 (also called battery cells or single galvanic cells or prismatic cells).

Each of the electrochemical cells 2 comprises a pair of electrodes A and K, whereby one of the electrodes A is an anode or negative electrode and the other electrode K is a cathode or positive electrode.

To electrically connect the electrochemical cells 2 with each other the electrodes A and K of each cell 2 are connected with outward terminals 3.A and 3.K. Depending on the application the electrochemical cells 2 can be connected through the outward terminals 3.A and 3.K in parallel, in series or in parallel-series.

The shown embodiment according to FIG. 1 presents electrochemical cells 2 which are connected in series.

One of the electrochemical cell 2 is shown in FIG. 2 in more detail.

Each electrochemical cell 2 is a flat cell, which comprises e.g. as electrodes A and K a plurality of inner electrode films A1 to An and K1 to Kn, whereby different electrode films A1 to An and K1 to Kn separated by a not shown separator film. This separator film rinses with an e.g. non-aqueous electrolyte. Alternatively, instead of films for the electrodes A, K and the separator plates can be used.

Depending on the kind of cell 2, e.g. a lithium-ion cell; the electrode films A1 to An, K1 to Kn are divided in two different groups. One group of the electrode films A1 to An represents the cathode electrode K, e.g. of metal lithium, the other group of electrode films K1 to Kn represents the anode electrode A, e.g. of lithium graphite.

For connecting the outward terminals 3.A, 3.K with the respective electrode A, K of each electrochemical cell 2 the cell 2 comprises inner electrode conductors 4.A, 4.K. In more detail, the inner electrode films A1 to An and K1 to Kn of the respective electrode A and K are electrically connected with each other through the inner electrode conductors 4.A and 4.K in that the inner electrode conductors 4.A and 4.K of the different electrodes A and K are arranged on opposite sides of the electrochemical cell 2 in electrode material-free area of the respective electrode films A1 to An and K1 to Kn.

For a fixed connection of the inner electrode films A1 to An and K1 to Kn of each electrode A and K each inner electrode conductor 4.A and 4.K is provided with a predetermined number of weld points 5.1 to 5.z in the electrode material-free area of the respective electrode films A1 to An and K1 to Kn of the respective electrode A and K. Such fixed connection of the inner electrode films A1 to An and K1 to Kn allows also a fixed connection of the separator films arranged between the electrode films A1 to An, K1 to Kn.

Furthermore, each inner electrode conductor 4.A and 4.K comprises a predetermined number of openings 6.1 to 6.m through the inner electrode films A1 to An and K1 to Kn in which coupling elements (not shown) are set to connect the inner electrode conductor 4.A and 4.K, especially the inner electrode films A1 to An and K1 to Kn with an outward electrode conductor 7.A and 7.K (dotted line for hidden conductor) for the respective electrode A and K.

The outward electrode conductor 7.A, 7.K is provided e.g. as a conductor bar. Preferably, the outward electrode conductor 7.A, 7.K is composed of at least copper.

Additionally, the outward electrode conductor 7.A, 7.K can be composed of at least copper coated with a protection layer which is composed of e.g. stannous or nickel or an alloy, e.g. an alloy of aluminium manganese or aluminium copper.

Alternatively, the outward electrode conductor 7.A, 7.K can be composed of at least copper with a treated surface, e.g. with a surface treated by an electronic beam. Furthermore, each outward electrode conductor 7.A, 7.K has a thickness of at least 1 mm. The thickness can vary based on particular applications, e.g. of the size of the electrochemical cell 2. The larger the cell 2 is, the larger is the thickness of the outward electrode conductor 7.A, 7.K. For example, the thickness should be in the range of about 1 mm to about 3 mm.

As a possible embodiment the coupling elements set in the openings 6.1 to 6.m can be rivets, crimps or bolts which could optionally be welded. Alternatively, the coupling elements are provided by bulges or knobs which are welded and integrated in the inner electrode films A1 to An and K1 to Kn.

In a preferred embodiment the number of weld points 5.1 to 5.z of the connected inner electrode films A1 to An and K1 to Kn in the respective inner electrode conductor 7.A and 7.K is greater than the number of openings 6.1 to 6.m or coupling elements in the respective inner electrode conductor 7.A and 7.K. Preferably, the relation between the number of weld points 5.1 to 5.z and the number of openings 6.1 to 6.m or coupling elements is in the range between 2.0 and 3.0.

As shown in FIG. 2, each outward electrode conductor 7.A, 7.K is connected with a respective outward terminal 3.A, 3.K.

Furthermore, the arrangement of electrode films A1 to An, K1 to Kn with separator films can be surrounded by a casing 4. The casing 4 can be provided as a film casing or a plate casing which isolates the cell 2 against other cells.

Preferably, the cells 2 are at least electrically isolated of each other. Additionally, the cells 2 can be thermally isolated of each other depending on the used material. Alternatively, the cells 2 can be electrically connected through the casing surface. Another alternative embodiment can be provided in that a material, e.g. a resin, is filled between the cells 2 for electrical isolation.

The whole energy storage assembly 1 can also be surrounded by a not shown casing, e.g. by a plate casing or a film casing (also called “soft-pack”).

Alternatively, sensor elements, such as temperature sensor elements, can be directly integrated in the outward terminal 3.A, 3.K. This allows a very efficient temperature measurement.

Especially, depending on the size of the energy storage assembly 1 the thickness of each outward terminal 3.A, 3.K can be varied in a range of 1 mm to 3 mm. In one embodiment, each outward terminal 3.A, 3.K can have a thickness of at least 1 mm. Alternatively, the outward terminals 3.A, 3.K can have a different thickness in the above mentioned range depending on the available space and required compactness and tightness.

Furthermore, the outward terminals 3.A, 3.K can be formed differently in that the current distribution from the respective cell 2 is efficiently performed. For instance, the connecting end of each outward terminal 3.A, 3.K can be taken a cone form. The connecting end of each outward terminal 3.A, 3.K is the end through the terminal 3.A, 3.K is connected with the respective inner electrode conductor 7.A, 7.K.

Preferably, each outward terminal 3.A, 3.K is composed of at least copper. Each outward terminal 3.A, 3.K is composed of the same material. This allows the same welding temperature. Furthermore, each outward terminal 3.A, 3.K can be composed of at least copper coated with a protection layer. Preferably, the protection layer is composed of stannous or nickel against corrosion. The protection layer is very thin. For instance, the protection layer has a thickness of a few μm.

1.-17. (canceled)

18. Electrochemical cell with a pair of electrodes arranged as a stack of flat electrode films separated by a separator film, wherein electrode films of each electrode are electrically connected with each other through inner electrode conductors,
wherein the inner electrode conductors of the electrodes are arranged on opposite sides of the electrochemical cell in an electrode material-free area of the electrode films,
wherein each inner electrode conductor is connected with the respective electrode films through a predetermined number of weld points in the electrode material-free area of the respective electrode,
wherein each inner electrode conductor comprises a predetermined number of openings in which coupling elements are set to connect the inner electrode conductor with an outward electrode conductor for the respective electrode.

19. Electrochemical cell according to claim 18, wherein the outward electrode conductor is a conductor bar.

20. Electrochemical cell according to claim 18, wherein the outward electrode conductor is composed of at least copper.

21. Electrochemical cell according to claim 18, wherein the outward electrode conductor is composed of at least copper coated with a protection layer.

22. Electrochemical cell according to claim 21, wherein the protection layer is composed of stannous or nickel or an alloy.

23. Electrochemical cell according to claim 22, wherein the alloy is an alloy of aluminum manganese or aluminum copper.

24. Electrochemical cell according to claim 18, wherein the outward electrode conductor is composed of at least copper with a treated surface.

25. Electrochemical cell according to claim 18, wherein the treated surface is treated with an electronic beam.

26. Electrochemical cell according to claim 18, wherein the coupling elements are rivets, crimps or bolts or bulges or knobs integrated in the inner electrode conductor.

27. Electrochemical cell according to claim 18, wherein the number of weld points is greater than the number of openings.

28. Electrochemical cell according to claim 18, wherein a relation between the number of weld points and the number of openings is in the range of between 2.0 and 3.0.

29. Electrochemical cell according to claim 18, wherein each outward electrode conductor is connected with a respective outward terminal.

30. Energy storage assembly with a plurality of flat electrochemical cells according to claim 18.

31. Energy storage assembly according to claim 30, wherein each of the cells comprises a pair of electrodes which electrically connect the electrochemical cells with each other through the outward terminals.

32. Energy storage assembly according to claim 30, wherein the electrochemical cells are connected in series.

33. Energy storage assembly according to claim 30, wherein the electrochemical cells are connected parallelly.

34. Energy storage assembly according to claim 30, wherein the electrochemical cells are connected in parallel-series.

35. An electric car having a driving motor driven by power supplied from the energy storage assembly according to claim 30.

36. A hybrid type electric car having a driving motor and an internal combustion engine, wherein the driving motor is driven by power supplied from the energy storage assembly according to claim 30.
